(19) United States
(12) Patent Application Publication
(10) Pub. No.: US 2016/0101017 A1
(43) Pub. Date: Apr. 14, 2016

(54) RETRACTABLE HALF-BODY SAUNA DEVICE

(71) Applicant: Sang Won LEE, Yorba Linda, CA (US)

(72) Inventor: Sang Won LEE, Yorba Linda, CA (US)

(21) Appl. No.: 14/511,480

(22) Filed: Oct. 10, 2014

(51) Int. Cl. A61H 33/06; A61H 33/00

(52) U.S. Cl. CPC A61H 33/066; A61H 33/6005; A61H 2201/0161

(57) ABSTRACT

A retractable half-body sauna device includes a main body, a retractable body, a first sliding member, and a second sliding member. The first sliding member is installed along inner surfaces of the bottom plate, the two side plates, or the bottom plate and the two side plates of the main body. The second sliding member is installed along outer surfaces of the bottom plate, the two side plates, or the bottom plate and the two side plates of the retractable body. The first and second sliding members are configured for engaging and sliding on each other so as to the retractable body is pulled partially out of and pushed partially into the main body, such that an inner space defined by the main body and the retractable body gets maximized and minimized, respectively.

### BACKGROUND OF THE INVENTION

The present invention relates to a retractable half-body sauna device.

Sauna devices are popular because they help users to enjoy and facilitate their body conditions.

However, the conventional sauna devices had some problems in using environment and space, especially in a congested area.

Accordingly, a need for a retractable sauna device has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a retractable half-body sauna device.

According to an aspect of the invention, a retractable half-body sauna device comprises a main body, a retractable body, a first sliding member, and a second sliding member.

The main body comprises a bottom plate, a back plate, two side plates, a top opening, and a front opening.

The retractable body comprises a bottom plate, a front plate, two side plates, a top plate, and a rear opening.

The first sliding member is installed along inner surfaces of the bottom plate, the two side plates, or the bottom plate and the two side plates of the main body.

The second sliding member is installed along outer surfaces of the bottom plate, the two side plates, or the bottom plate and the two side plates of the retractable body.

The first and second sliding members are configured for engaging and sliding on each other so as to the retractable body is pulled partially out of and pushed partially into the main body, such that an inner space defined by the main body and the retractable body gets maximized and minimized, respectively.

The first sliding member may be installed along the inner surface of the bottom plate of the main body only, and the second sliding member may be installed along the outer surfaces of the bottom plate of the retractable body only.

The first and second sliding members may comprise a plurality of rollers.

The first and second sliding members may comprise a plurality of guide rails.

The retractable half-body sauna device may further comprise a sealing member, which is installed partially along an edge of the rear opening of the retractable body and configured for sealing a bordering gap between the main body and the retractable body around the rear opening of the retractable body.

The sealing member may comprise a flange made of rubber or silicon.

The retractable half-body sauna device may further comprise a stopper comprising a first stopping member disposed in the main body and a second stopping member disposed in the retractable body and configured for limiting a degree of retracting of the retractable body out of the main body.

The retractable half-body sauna device may further comprise a first heater disposed under a chair portion installed on the bottom plate of the main body.

The retractable half-body sauna device may further comprise a second heater disposed on the bottom plate of the retractable body.

The retractable half-body sauna device may further comprise one or more doors installed through the two side plates of the main body.

The retractable half-body sauna device may further comprise a front cover disposed on a front edge of the top opening of the main body and a rear cover disposed on a rear edge of the top opening of the main body. The front cover and the rear cover define a through-hole an upper body of a user.

The retractable half-body sauna device may further comprise two wheels installed on a front edge of the bottom plate of the retractable body.

The advantages of the present invention are: (1) the retractable half-body sauna device according to the invention enables to save lots of space; and (2) the retractable half-body sauna device according to the invention has a simple structure.

Although the present invention is briefly summarized, the fuller understanding of the invention can be obtained by the following drawings, detailed description and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 is a perspective view showing a retractable half-body sauna device according to an embodiment of the invention;

FIG. 2 is a side view showing a retractable half-body sauna device with a user sitting on a chair portion according to an embodiment of the invention;

FIG. 3 is a side view showing a retractable half-body sauna device in an extended state according to an embodiment of the invention;

FIG. 4 is a side view showing a retractable half-body sauna device in a retracted state according to an embodiment of the invention;

FIG. 5 is a perspective view showing a retractable half-body sauna device in a partially retracted state according to an embodiment of the invention;

FIG. 6 is a perspective view showing a retractable half-body sauna device in a retracted state with a front cover and a door ajar according to an embodiment of the invention;

FIG. 7 is a front view showing a retractable half-body sauna device according to an embodiment of the invention;

FIG. 8 is a perspective view showing a front cover in an opened and partially closed sates of a retractable half-body sauna device according to an embodiment of the invention;

FIG. 9 is a partial front perspective view of FIG. 6;

FIG. 10 is a side view showing a retractable half-body sauna device with a door opened according to an embodiment of the invention;

FIG. 11 is a exploded side view showing a main body and a retractable body disassembled according to an embodiment of the invention; and

FIG. 12 is a partial cross-sectional view showing a stopper according to an embodiment of the invention.

### DETAILED DESCRIPTION EMBODIMENTS OF THE INVENTION

Referring to the figures, the embodiments of the invention are described in detail.

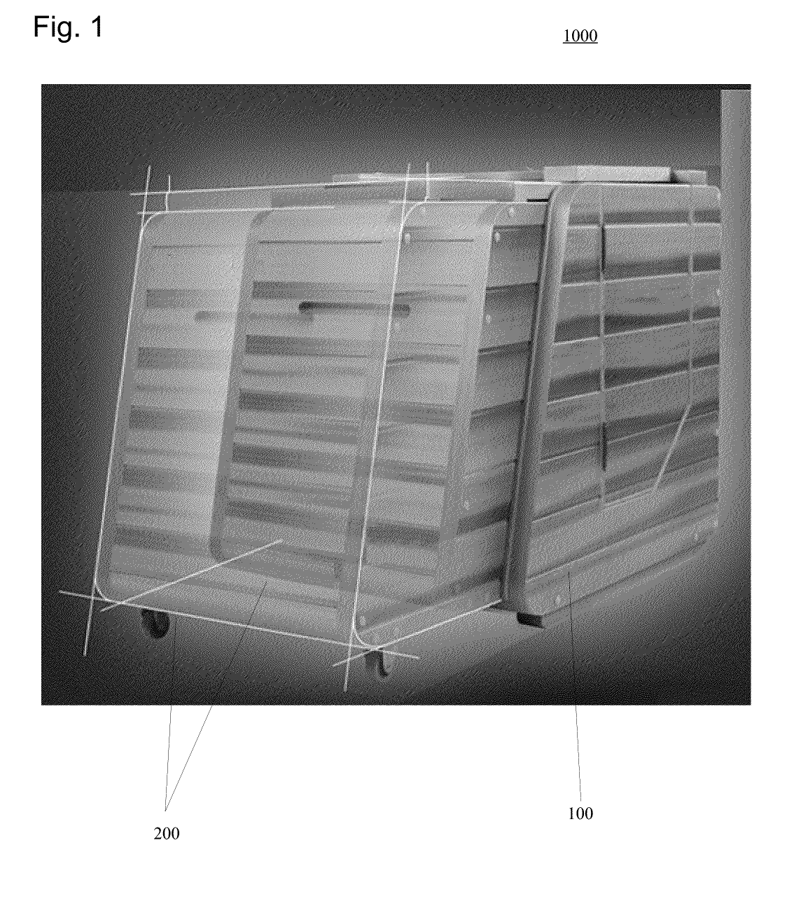

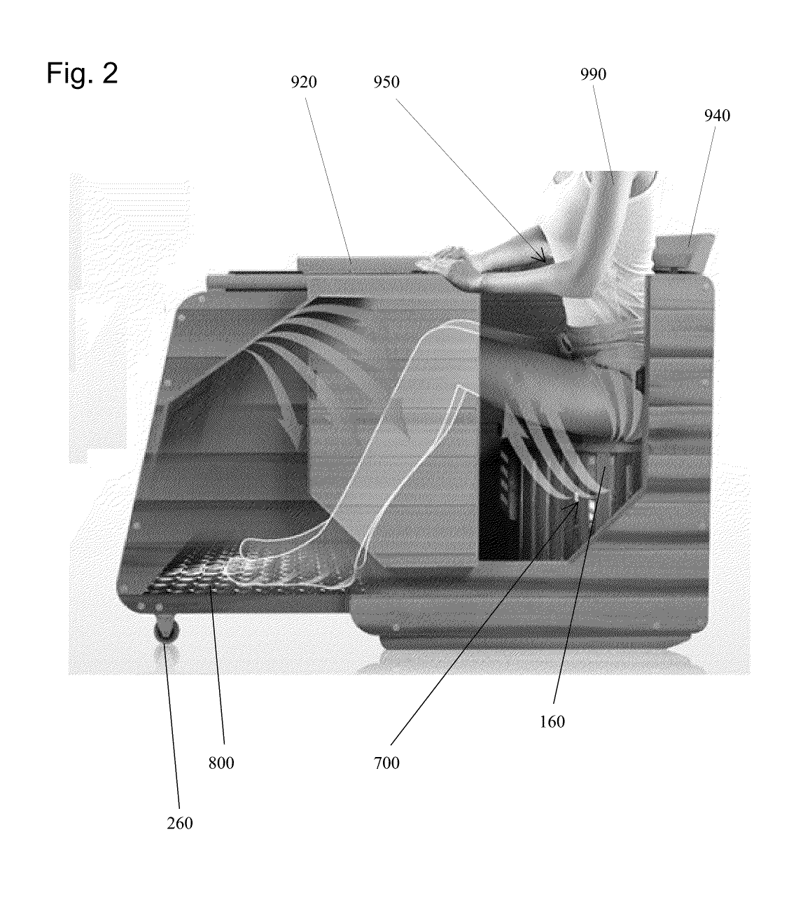

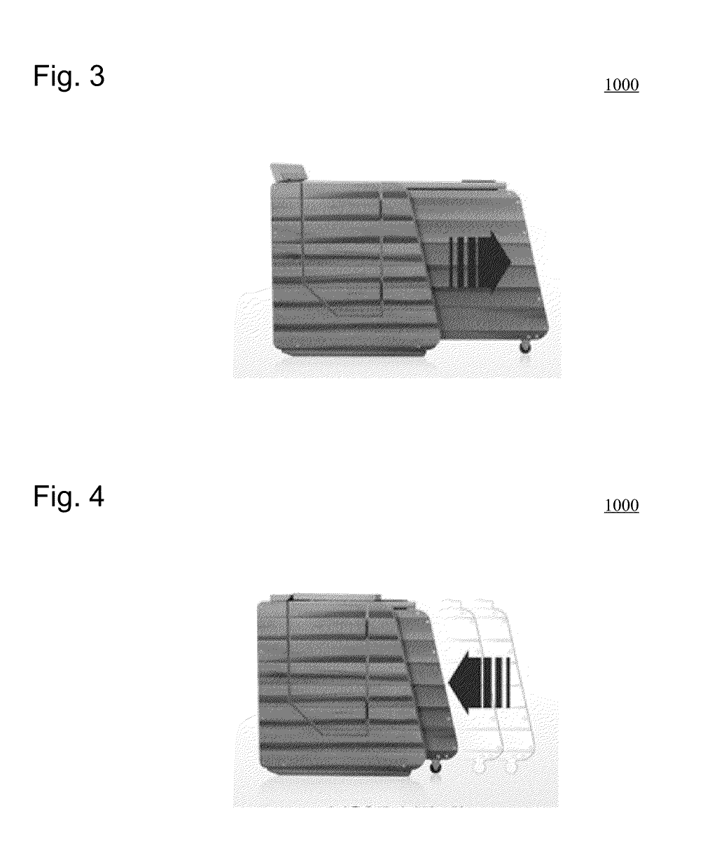

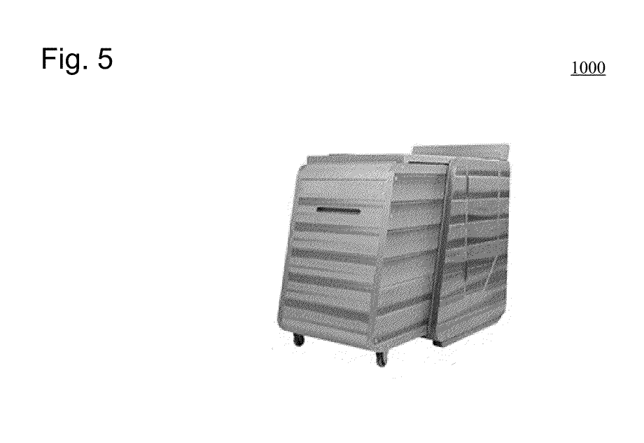

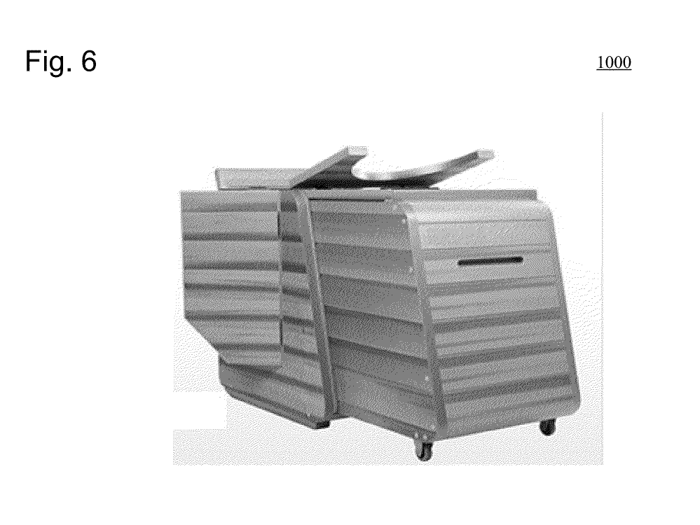

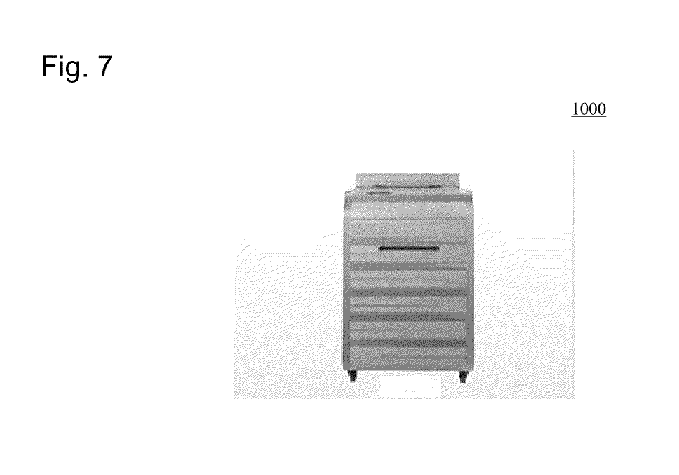

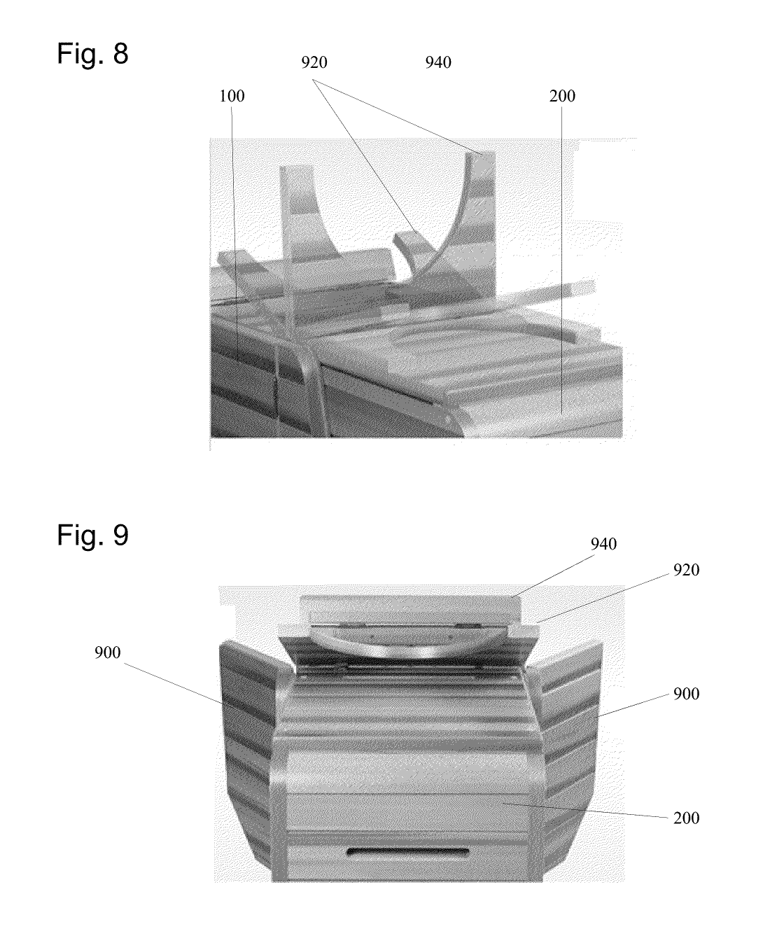

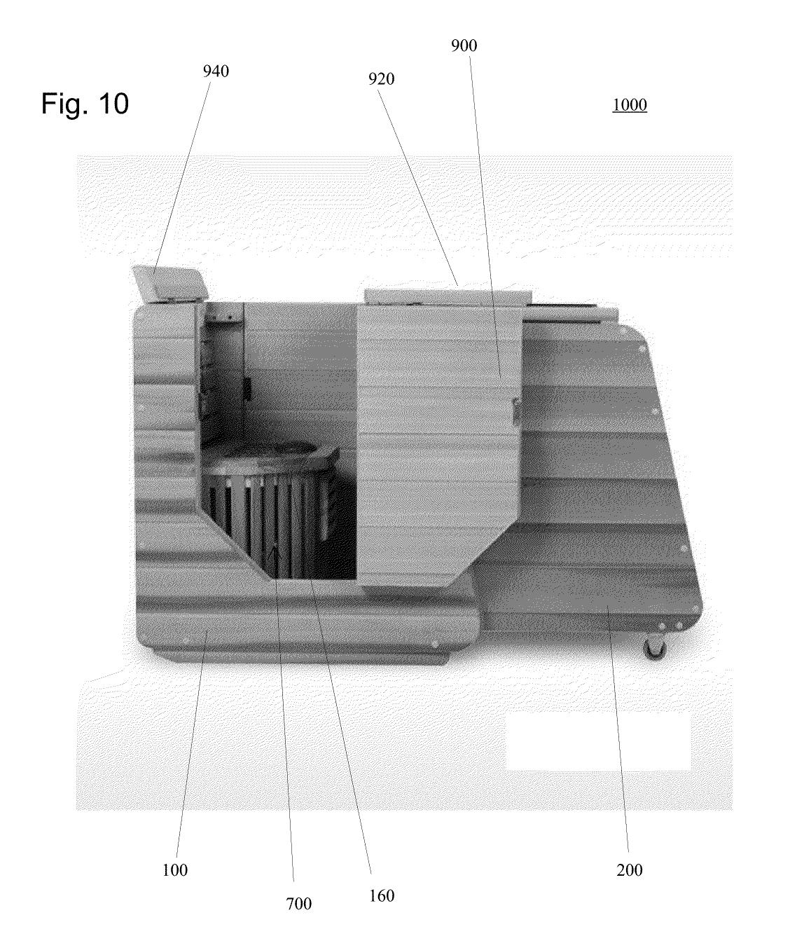

FIGS. 1, 5, and 6 show perspective views of a retractable half-body sauna device according to an embodiment of the invention, FIGS. 2 and 10 show side views of a retractable half-body sauna device according to an embodiment of the invention, FIGS. 3 and 4 show side views of a retractable half-body sauna device in an extended and retracted states according to an embodiment of the invention, and FIGS. 8 and 9 show perspective views of a front cover in an opened and partially closed sates of a retractable half-body sauna device according to an embodiment of the invention.

An object of the invention is to provide a retractable half-body sauna device.

According to an aspect of the invention, a retractable half-body sauna device 1000 comprises a main body 100, a retractable body 200, a first sliding member 300, and a second sliding member 400.

The main body 100 comprises a bottom plate 110, a back plate 120, two side plates 130, a top opening 140, and a front opening 150.

The retractable body 200 comprises a bottom plate 210, a front plate 220, two side plates 230, a top plate 240, and a rear opening 250.

The first sliding member 300 is installed along inner surfaces of the bottom plate 110, the two side plates 120, or the bottom plate 110 and the two side plates 120 of the main body 100.

The second sliding member 400 is installed along outer surfaces of the bottom plate 210, the two side plates 220, or the bottom plate 210 and the two side plates 220 of the retractable body 200.

The first and second sliding members 300, 400 are configured for engaging and sliding on each other so as to the retractable body 200 is pulled partially out of and pushed partially into the main body 100, such that an inner space defined by the main body 100 and the retractable body 200 gets maximized and minimized, respectively.

The first sliding member 300 may be installed along the inner surface of the bottom plate 110 of the main body 100 only, and the second sliding member 400 may be installed along the outer surfaces of the bottom plate 210 of the retractable body 200 only.

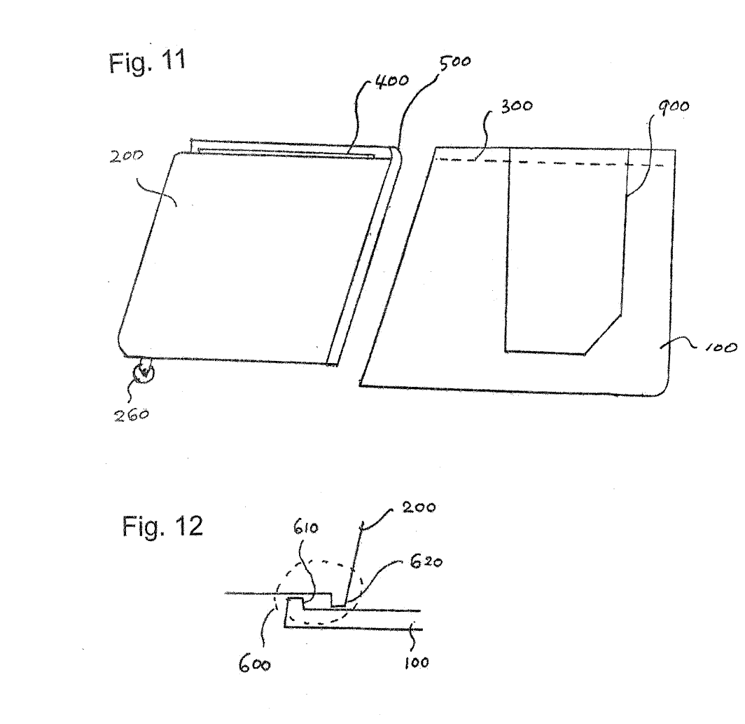

The first and second sliding members 300, 400 may comprise a plurality of rollers as shown in FIG. 11.

The first and second sliding members 300, 400 may comprise a plurality of guide rails as shown in FIG. 11.

In the embodiment illustrated in FIG. 11, the sliding members are installed at upper portions of the two side plates as a guide groove at the retractable body 200, in which corresponding sliding member such as rollers may be disposed along the dashed line on the main body. The sliding members can be realized by any conventional devices for the same purposes.

The retractable half-body sauna device 1000 may further comprise a sealing member 500, which is installed partially along an edge of the rear opening 250 of the retractable body 200 and configured for sealing a bordering gap between the main body 100 and the retractable body 200 around the rear opening 250 of the retractable body 200 as shown in FIG. 11.

The sealing member 500 may comprise a flange made of rubber or silicon. Of course, any conventional devices for the same purposes can be used for the sealing member 500.

In certain embodiments of the invention, the sealing member 500 may further comprise another corresponding sealing member (not shown) provided on the inner surfaces of the main body 100 for securing the sealing function.

The retractable half-body sauna device 1000 may further comprise a stopper 600 comprising a first stopping member 610 disposed in the main body 100 and a second stopping member 620 disposed in the retractable body 200 and configured for limiting a degree of retracting of the retractable body 200 out of the main body 100. Of course, any stopper devices for the same purposes can be used for the stopper 600 as shown in FIG. 12.

The retractable half-body sauna device 1000 may further comprise a first heater 700 disposed under a chair portion 160 installed on the bottom plate 110 of the main body 100. The first heater 700 may be installed safely inside the chair portion 160, such that any hot portion of the first heater 700 does not contact the user.

The retractable half-body sauna device 1000 may further comprise a second heater 800 disposed on the bottom plate 210 of the retractable body 200. Likewise, The second heater 800 may be installed safely inside the bottom plate 210, such that any hot portion of the second heater 800 does not contact the user 990.

The retractable half-body sauna device 1000 may further comprise one or more doors 900 installed through the two side plates 120 of the main body 100.

The retractable half-body sauna device 1000 may further comprise a front cover 920 disposed on a front edge of the top opening 140 of the main body 100 and a rear cover 940 disposed on a rear edge of the top opening 140 of the main body 100. The front cover 920 and the rear cover 940 define a through-hole 950 for an upper body of a user 990.

The retractable half-body sauna device 1000 may further comprise two wheels 260 installed on a front edge of the bottom plate 210 of the retractable body 200.

Another aspect of the invention may provide more details of each part of the retractable half-body sauna device 1000.

For example, the first and second sliding members 300, 400 may provided in any form between the inner surfaces of the main body 100 and the outer surfaces of the retractable body 200. They may be rollers and guide rails disposed horizontally, for example.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A retractable half-body sauna device, the device comprising:
a main body comprising a bottom plate, a back plate, two side plates, a top opening, and a front opening;
a retractable body comprising a bottom plate, a front plate, two side plates, a top plate, and a rear opening;
a first sliding member installed along inner surfaces of the bottom plate, the two side plates, or the bottom plate and the two side plates of the main body; and
a second sliding member installed along outer surfaces of the bottom plate, the two side plates, or the bottom plate and the two side plates of the retractable body,
wherein the first and second sliding members are configured for engaging and sliding on each other so as to the retractable body is pulled partially out of and pushed partially into the main body, such that an inner space defined by the main body and the retractable body gets maximized and minimized, respectively.

2. The retractable half-body sauna device of claim 1, wherein the first sliding member is installed along the inner surface of the bottom plate of the main body only, and wherein the second sliding member installed along the outer surfaces of the bottom plate of the retractable body only.

3. The retractable half-body sauna device of claim 2, wherein the first and second sliding members comprise a plurality of rollers.

4. The retractable half-body sauna device of claim 3, wherein the first and second sliding members comprise a plurality of guide rails.

5. The retractable half-body sauna device of claim 1, further comprising a sealing member installed partially along an edge of the rear opening of the retractable body and configured for sealing a bordering gap between the main body and the retractable body around the rear opening of the retractable body.

6. The retractable half-body sauna device of claim 5, wherein the sealing member comprises a flange made of rubber or silicon.

7. The retractable half-body sauna device of claim 1, further comprising a stopper comprising a first stopping member disposed in the main body and a second stopping member disposed in the retractable body and configured for limiting a degree of retracting of the retractable body out of the main body.

8. The retractable half-body sauna device of claim 1, further comprising a first heater disposed under a chair portion installed on the bottom plate of the main body.

9. The retractable half-body sauna device of claim 8, further comprising a second heater disposed on the bottom plate of the retractable body.

10. The retractable half-body sauna device of claim 1, further comprising one or more doors installed through the two side plates of the main body.

11. The retractable half-body sauna device of claim 1, further comprising:
a front cover disposed on a front edge of the top opening of the main body; and
a rear cover disposed on a rear edge of the top opening of the main body,
wherein the front cover and the rear cover define a through-hole an upper body of a user.

12. The retractable half-body sauna device of claim 1, further comprising two wheels installed on a front edge of the bottom plate of the retractable body.
